(19) United States
(12) Patent Application Publication
(10) Pub. No.: US 2008/0085974 A1
(43) Pub. Date: Apr. 10, 2008

(54) Process for Preparing Water-Soluble Polymer Gels

(76) Inventor: Edwin T. Sortwell, St. Simons Island, GA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/929,507

(22) Filed: Oct. 30, 2007

Related U.S. Application Data
(63) Continuation-in-part of application No. 11/641,374, filed on Dec. 18, 2006, now abandoned.
(63) Continuation-in-part of application No. PCT/US2006/048553, filed on Dec. 18, 2006.
(60) Provisional application No. 60/751,693, filed on Dec. 19, 2005.
(60) Provisional application No. 60/751,693, filed on Dec. 19, 2005.

(51) Int. Cl. C08F 2/16

(52) U.S. Cl. 524/804

(57) ABSTRACT

A process for preparing high molecular weight water-soluble polymer gels having relatively narrow molecular weight distributions is disclosed. An aqueous reaction mixture comprising a solution of a water-soluble vinyl monomer and a suitable catalyst system is polymerized in a reactor comprising a channel reactor with sealed removable lid in the substantial absence of oxygen. The sealed removable lid is preferably flexible and sealed with a flexible zipper. The polymer gels are formed into particles or pellets and coated. The coating allows the gel to flow or be pumped and metered. Gel particles or pellets may also be dried to granular product.

### CROSS-REFERENCE TO RELATED APPLICATIONS

This is a continuation-in-part of U.S. application Ser. No. 11/641,374 filed Dec. 18, 2006, and International Application PCT/US2006/048553 filed Dec. 18, 2006, both of which in turn claim the priority of U.S. Provisional Patent Application Ser. No. 60/751,963 filed Dec. 19, 2005, the entire respective disclosures of which are incorporated herein by reference.

### BACKGROUND OF THE INVENTION

1. Field of the Invention

The invention relates generally to a method of preparing water-soluble polymer gels and, more particularly, the invention is directed to a process for preparing a water-soluble polymer gel having a relatively narrow molecular weight distribution and a relatively high molecular weight. Further, the invention relates to a method of coating, handling, shipping, and metering water-soluble gels, or drying of water-soluble gels to form granular polymer.

2. Related Technology

The production of water-soluble polymers by the polymerization of water-soluble vinyl monomers in aqueous solutions is well known. Such polymerizations are often carried out in solution using relatively dilute monomer (and resulting polymer) concentrations, and in gel polymerization systems wherein relatively concentrated monomer solutions and resulting polymer gel products are obtained.

Gel polymerization processes are advantageously carried out in the substantial absence of oxygen (which is a polymerization inhibitor for vinyl monomers) in the presence of a suitable reaction initiator (e.g., organic free radical generating initiators, redox initiation systems, etc.) in deep reactors whereby a product having a thick cross-section is produced. The polymerization reaction is strongly exothermic and in a reactor wherein the depth of the product is large, temperature gradients tend form which result in non-uniform reaction rates across the product, resulting in often widely variable molecular weight distributions in gel products.

Prior polymerization systems and equipment typically are large, complicated, and expensive, or require multiple steps for implementation and control, which may adversely affect quality control. In some cases, prior systems require multiple batch operation.

Prior thin film polymerization (i.e., continuous band polymerization) systems are mechanically and chemically complicated and very expensive.

U.S. Pat. No. 5,185,409 (Feb. 9, 1993) addresses the concerns of the prior art. U.S. '409 describes the use of an oxygen impervious bag to provide a reaction vessel for polymerization to produce a superior high molecular weight polymer. While technically feasible, this process is limited in its physical practicality, due to difficulties in ensuring an oxygen-free environment within the reactor, as required for uniform polymerization. Folds in the bag may trap air prior to filling the bag with monomer solution. In addition, the bag itself is unavoidably destroyed in removing the polymer gel. The cost of the bag and its disposal negatively affect process efficiency and economics.

The removal of polymer gel from the bag presents additional problems. Water-soluble gels are generally ground and dried after production in order to produce a shippable product. The ground, dried product is then packaged in paper bags or bulk sacks for shipping.

Following production of gel, prior practice was to grind and dry the gel to produce a granular product for packaging and shipment. Grinding is an inexpensive step, but drying requires significant capital investment and is energy intensive. The drying step requires elevating temperatures close to, or above, the boiling point of water. Exposing the polymer molecules to these drying temperatures often degrades the polymer and impairs its performance as a flocculent, for example. There are, however, flocculant applications where dry, granular polymer application systems already exist. In this instance, it may be necessary to supply dry, granular product for competitive reasons. If the gel is to be dried, extra care must be taken to ensure that polymer degradation is minimized.

### SUMMARY OF THE INVENTION

The invention produces a practical functional approach to achieving, and enhancing, polymer properties in a gel polymerization process.

According to the invention, at least one vinyl monomer is polymerized to form a polymer gel by preparing a substantially oxygen-free reaction mixture of an aqueous solution of the monomer(s) and a suitable catalyst system, introducing the reaction mixture to substantially oxygen-free reactor, which is a channel formed on the floor of a production building to provide the necessary reactor configuration, such channel being fitted with a sealing, but removable, lid, and allowing the reaction mixture to polymerize in the channel in an essentially oxygen-free environment.

Selection of the catalyst system, the concentration thereof, and the reactor dimensions allows the preparation of water-soluble polymer gels having a desired intrinsic viscosity with a relatively narrow molecular weight distribution.

The reaction system of the invention is simple and economical to operate, and does not require large capital investment. A simple closed agitated tank, and a sufficient length of floor space with a channel to act as the reactor are sufficient.

Ground gel can be packaged and shipped in a variety of containers as easily as if it were a granular solid or a liquid. Furthermore, the ground gel can be pumped and metered as if it were a liquid, simplifying application costs and technology (dry polymer cannot be pumped). Fluidizing of the gel particles may be accomplished by coating the gel particles (or pellets) with a non-absorbing, high-pressure-resistant material during or immediately after grinding. Modified vegetable or mineral oil is such a material.

Other objects and advantages of the invention may be apparent to those skilled in the art from the following detailed description, taken in conjunction with the drawings and the appended claims.

### BRIEF DESCRIPTION OF THE DRAWINGS

FIG. 1 is a cross-sectional view of a reactor used in the process of the invention.

FIG. 2 is a cross-sectional view of the reactor of FIG. 1 with polymerized gel in place in the reactor.

FIG. 3 is an elevated view of a gel slab grinding and coating apparatus.

### DETAILED DESCRIPTION OF THE INVENTION

According to the invention, water-soluble polymers of vinyl (e.g., acrylic) monomers are prepared by utilizing commercially available monomer solutions or dissolving the solid monomer in water to a desired monomer concentration, which is generally about 20 wt. % to about 60 wt. %, and preferably at least about 28 wt. %. The monomer solution is then purged of oxygen by a stream of inert gas, preferably nitrogen gas, and a catalyst system is added to the purged solution with thorough mixing in a mixing vessel. In one embodiment, separate components of a multicomponent catalyst system are generally added stepwise with intermediate thorough mixing of each component.

After addition and mixing of the catalyst system (or the final catalyst component) and before significant viscosity build-up can reduce mobility, the reaction mixture is introduced (e.g., by gravity) into a reactor formed by a channel with a sealing, removable lid, which has previously been purged of oxygen with nitrogen or another inert gas. The reactor has a depth of about 20 inches or less, and preferably a width of four feet or more. The depth of the reaction mixture is at least about two inches and preferably less than about ten inches, and highly preferably about six to about eight inches.

The inert gas enclosed in the channel and contained by the sealed, removable lid is displaced by the reaction mixture from the reactor and is recycled into the mixing vessel from the channel in order to maintain a substantially oxygen-free atmosphere during the transfer. The gas recycle is preferably supplemented by additional inert gas as need to maintaining a positive inert gas pressure in the mixing vessel relative to the atmosphere.

The polymerization reaction takes place inside the channel reactor, covered by the sealed lid, and the resulting reacted slab of gel is removed for grinding, and packaging. The channel may be formed by constructing raised sides on an existing floor or by forming the reaction channel into a concrete floor of a production facility during building construction. The walls of the channel should be slightly sloped so as to be wider at the top than at the bottom to facilitate removal of the polymer slab. The bottom and walls of the channel can be coated to prevent the concrete from interfering with the polymerization reaction, and to reduce any adhesion of the gel to the channel. The removable, sealing lid can be fabricated from any of a variety of materials, and either may be rigid or flexible. A preferred sealing lid is fabricated from flexible plastic and sealed with a flexible zipper of the type manufactured by MDH Packaging under the trademark ARROWSLIDE.

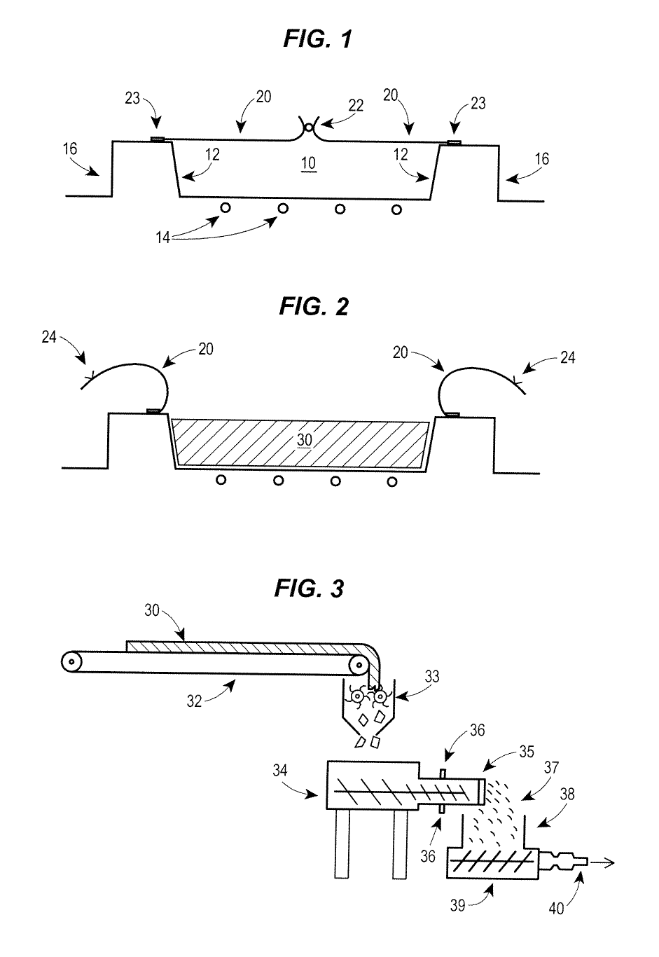

FIG. 1 of the drawings shows an end view of a gel casting channel 10 with slightly sloped sides 12 with optional heating/cooling pipes 14. The channel is formed by curbs (or sides) 16 and sealed with a flexible cover 20 by means of a flexible zipper 22. The flexible cover is fastened and sealed to the edge of the channel at 23.

FIG. 2 of the drawings shows an end view of the channel with a polymerized gel slab 30 in place and the flexible sealing folded back to allow removal of the gel slab. Each half of the flexible sealing lid has its half of the flexible zipper 24.

The end user's equipment for dissolving the flocculent in water will determine the delivered form of the product, either gel pellets or granular dry polymer. If conditions allow the use of gel pellets, not drying the gel minimizes any damage to the molecule and eliminates costs associated with drying and grinding.

FIG. 3 of the drawings shows a harvested slab of gel 30 on a motorized conveyor 32 feeding the gel slab into a coarse shredder 33. Coarse, shredded gel drops into a variable speed grinder/extruder 34 which meters gel through an extrusion plate 35. A lubricant coating (e.g., a lubricating, non-water-soluble material, such as a vegetable or mineral oil, for example an edible vegetable oil such as canola oil) is proportionately metered by a high pressure pump (not shown) into ports 36 on the barrel of the grinder/extruder 34. Coated gel pellets 37 drop into the hopper 38 of a variable-speed auger 39 that feeds gel particles into the suction of a progressive cavity pump 40. The pump 40 can feed gel to shipping containers or to dryers.

The addition of an oil-soluble surfactant to the oil improves the coatability of the pellets of polymer gel. Either a low HLB or high HLB surfactant may be employed to improve coatability; however, long-term separability of pellets that have been compressed is enhanced with a high HLB surfactant is used. The high HLB surfactant also enhances the subsequent dissolution of the polymer pellets into water for final end use. The addition of a high HLB oil-soluble surfactant such as TWEEN 60 or BRIJ 700, manufactured by Uniqema, or TRITON XL-80N, manufactured by Union Carbide, for example, may be employed.

Pellet or particle size is limited by the cavity size of the progressive cavity pump to handle the gel pellets and by the size which can be dissolved in a reasonable time by the final user. Generally, pellets will be 1/16th to ¼ inch in diameter and length with coatings of up to 5% and up to 2%, respectively, but in all cases the minimum level of coating is used, consistent with lubricity, pumpability, and particle separability.

The gel production capacity of the process is limited only by the size of the monomer preparation tank and/or the length and width of the channel. If desired, polymerization reaction conditions may be modified by cooling or heating using the pipes buried below the channel.

The resulting polymer exhibits much less variability in molecular weight than commercially available gel-based polymers made by other means. The reaction system is relatively simple and low cost, and the elimination of the drying step, while still producing a pumpable product, is a major economic breakthrough.

The process of the invention is applicable to the polymerization of any of a wide variety of ethylenically unsaturated water-soluble monomers including, for example, acrylamide, acrylic and methacrylic acids and water-soluble salts thereof; alkyl aminoalkyl esters of acrylic and methacrylic acids in the corresponding quaternary ammonium derivates thereof; and 2-vinylimdazoline and 2-vinylpyrimidine and the corresponding quartanarium ammonium derivatives thereof. Such monomers may be homopolymerized or polymerized with one or more comonomers.

Acrylamide is a preferred monomer for use in the invention.

The polymerization reaction is strongly exothermic in nature and therefore acrylamide monomer concentrations of greater than about 30 wt. % for homopolymerization are generally not desired. Somewhat higher concentrations (e.g., up to about 60 wt. %) may be utilized for the preparation of other homopolymers or copolymers. The reaction is initiated at temperatures as low as 50° F. and may rise to up to 190° F., depending on the monomers and their concentrations.

The heat absorbing characteristics of the concrete base and walls of the channel reactor have provided an unexpected benefit. The concrete provides more efficient removal of the heat of reaction than was seen when practicing U.S. '409. Even without the use of cooling through the coils buried in the base of the channel, final gel temperature is lower for a given initiation temperature at a given monomer concentration. The lower the overall temperature increase during polymerization for a given monomer concentration, the lower the molecular weight distribution. Lower molecular weight distribution results in a more effective polymer for water clarification applications. Alternatively, the higher heat removal through the base and walls of the concrete channel can allow a higher monomer concentration, thus increasing polymer production.

Monomer concentrations in the range of about 20 wt % to about 30 wt. %, typically about 28 wt. %, are useful for the preparation of homopolymer acrylamide gels.

Gel polymerization processes of the invention are particularly useful in preparing acrylamide homopolymers having intrinsic viscosities (IV, Cannon-Ubbelodhe intrinsic viscosity in 4 wt. % aq. Sodium chloride) of about 19 and above. Anionic and cationic copolymers having high intrinsic viscosities are obtainable using the gel polymerization process of the invention.

The catalyst system comprises one or both of a free radical initator and a redox catalyst system. The redox component is of the type generally known in the art which allows the polymerization to be initiated at relatively low temperatures (e.g., about 50 to 55° F.). Such redox catalyst systems include a reducing agent and an oxidizing agent which react to form radical intermediates that initiate the polymerization of the monomer or of the monomer mixture. Suitable oxidizing agents include peroxides, chlorates, bromates, hypochlorites, peroxydisulfates, and atmospheric oxygen. Corresponding reducing agents are for example sulfites, mercaptans, sulfonates, thiosulfates, and hyposulfates. Suitable materials include persulfates such as potassium persulfate, for example, used with a sulfite such as sodium sulfite. Ammonium persulfate and ammonium ferrous sulfate are useful constituents of the redox system.

A useful redox catalyst system includes sodium bisulfite and ammonium persulfate.

The free radical initiator is an organic free radical generating initiator such as an azo compound capable of initiating the polymerization reaction at relatively high temperatures (e.g., about 75° F. and above). Such compounds and combinations thereof are disclosed in Tanaka, et al. U.S. Pat. No. 4,260,713 (Apr. 7, 1981), the disclosure of which is incorporated herein by reference. A preferred organic initiator is 2,2′-azobis (2-amidinopropane) dihydrochloride which is available from Wako Pure Chemical Industries (Osaka, Japan) under the trade designation V-50, V-30, V-76, and V-80 initiators from Wako are also useful, and initiate at different temperatures.

The concentration of the total catalyst system in the reaction mixture is may be within ranges generally known in the art, for example in the range of about 0.001 wt. % to about 0.002 wt. %. Concentrations in the range of about 0.00145 to about 0.00165 wt. % are preferred, and the weight ratio of the redox system to the organic free radical generator is preferably in the range of about 2.5:1 to about 3.5:1. If desired, however, either the redox system or the free radical generator may be used alone. If the free radical generator is used alone, the reaction mixture must be brought to a sufficiently high temperature (e.g., 70° F.) for initiation to take place, and this may call for a reduced monomer concentration.

A highly preferred catalyst system comprises 0.00056 wt. % sodium bisulfite, 0.00056 wt % ammonium persulfate, and 0.00042 wt % 2,2′-azolis (2-amidinopropane) dihydrochloride, based on total reaction mixture.

Chain transfer agents as known in the art (e.g., isopropyl alcohol, thiosulfates, etc.) may be present, if desired, to lower product molecular weight.

The molecular weight and thus the intrinsic viscosity of the polymer is a function of the amount of catalyst used, and the variability in these parameters is minimized by the use of a relatively thin reaction vessel.

The molecular weight distribution of the product can be directly varied by varying the proportion of the redox component to the organic component in the catalyst. Further, product molecular weight is an inverse function of total catalyst concentration, assuming that sufficient redox component is present to carry the reaction temperature to the organic initiator's threshold temperature.

The reaction vessel comprise a channel with a sealing, removable lid. The channel is preferably coated to reduce adherence of the resulting polymer gel.

The channel may be up to six feet wide or wider with ten to twelve inch slightly sloped sidewalls and may be filled to a desired depth (e.g., six to eight inches) with liquid reaction mixture, leaving a small (e.g., four to six inches) gap for an inert gas such as nitrogen. In any event, the thickness of the reaction mixture contained in the reactor should be less than 20 inches, preferably less than ten inches and more than two inches, highly preferably in the range of about six inches to about eight inches.

To carry out the reaction, the monomer(s) are dissolved in water, preferably in the presence of an oxygen purge. When ready to begin the reaction sequence, the monomer solution is purged of oxygen with a flow of nitrogen gas, preferably to an oxygen concentration of less than about 0.1 ppm. The nitrogen purge stream should contain about 5 ppm or less O₂.

The components of the catalyst system are then added in sequence, with at least one component of the redox system added after the addition of the organic free radical generator, unless the free radical generator is used alone. The components are added with thorough mixing after addition of each component.

A preferred catalyst addition sequence is ammonium persulfate followed by mixing (e.g., for two minutes), followed by addition of the organic free radical generator with mixing for two additional minutes, followed by the addition of the sodium bisulfite component of the redox system with mixing for two additional minutes. The resulting reaction mixture should be introduced to the reactor, preferably immediately (preferably within about five minutes after addition and mixing of the final catalyst component) and in any event before viscosity build-up compromises the fluidity of the reaction mixture.

The channel reactor with its sealed lid is purged of oxygen prior to introduction of the reaction mixture to the reactor. The reactor is closed at the end opposite the point of introduction, which is also closed after introduction of the reaction mixture.

When using dry acrylamide monomer, dissolving in water results in a drop in temperature of the resulting mixture due to the negative heat of dissolution of the monomer. For example, if 28 wt. % acrylamide monomer is added to water at a temperature of 75° F., the temperature will typically drop to a temperature in the range of about 53° F. to 55° F. Since the redox component of the catalyst system initiates the reaction at a relatively low temperature (e.g., 55° F.) the polymerization reaction will begin promptly after addition of the final redox component to the mixture. Since the reaction is exothermic, the temperature of the reaction mixture will rise as a reaction proceeds. When the reaction reaches a temperature of about 70° F., the organic free radical generator initiator will be activated and allow the reaction to proceed further at temperatures greater than 75° F. Alternatively the initial reaction temperature may be controlled in the monomer preparation vessel.

A maximum temperature of about 190° F. may be reached depending on the monomer concentration, and the reaction may be expected to proceed for up to about 7 hours, typically in the range of 3 hours to 7 hours (e.g., 4 hours) for acrylamide homopolymerization and preparation of anionic copolymers.

The characteristics of the process allow for the practical use of very much longer reaction times (e.g., days or weeks) without an attendant economic barrier or penalty other than the use of floor space. The invention allows the production of large quantities of product without substantially increased capital expenditures.

The narrowness of the molecular weight distribution is maximized by the use of a high surface area reactor channel, resulting in a lower solution viscosity for the high molecular weight later diluted products.

### EXAMPLES

The invention is illustrated by the following specific examples, which are not to limit the scope of the invention.

### Example 1

The following reaction mixture was used to prepare an acrylamide homopolymer having an IV of 19:

| Component | Weight % |
|---|---|
| Acrylamide | 28.0 |
| Water | 71.99846 |
| Ammonium Persulfate | 0.00056 |
| 2,2-Azobis[2-amidinopropane] | 0.00042 |
| dihydrochloride (Wako V-50) | |
| Sodium Bisulfite | 0.00056 |

5,500 pounds of dry acrylamide monomer is added to 14,140 pounds of demineralized water at 75° F., with mixing. After complete dissolution in the presence of oxygen, the monomer solution (at 53° F.) is transferred to a gel casting tank and the pH is adjusted to 4.0±0.2, while agitating, with dilute hydrochloric acid. The monomer solution is then purged with nitrogen to less than 0.15 ppm oxygen, the catalysts were added in the order given above the two minutes mixing after each addition. Following the final two minutes catalyst mix the entire solution is fed by gravity in five minutes into a previously nitrogen-purged channel with its sealed lid. Polymerization begins immediately and is essentially complete in four hours.

### Example 2

A mixture of 97 wt. % mineral oil and 3 wt. % TRITON XL-80N surfactant was prepared. The polymer produced according to Example 1 was extruded through a die plate with 3/16 inch holes and uniformly coated with the mixture. The mixture addition was 3% based on the weight of the polymer gel.

The coated pellets produced above were free-flowing and could be pumped by a progressive cavity pump. In order to simulate storage, the coated pellets produced above were compressed in a piston for six months. The pellets deformed under pressure to the appearance of a solid mass. On release of the pressure, the pellets sprang back to their original shapes, were free-flowing and could again be pumped with a progressive cavity pump.

The foregoing detailed description is given for clearness of understanding only, and no unnecessary limitations should be understood therefrom, as modifications within the scope of the invention will be apparent to those skilled in the art.

1. A process for preparing a water-soluble polymer gel comprising he steps of:
(a) forming an aqueous solution of one or more vinyl monomers:
(b) mixing said monomer solution with a catalyst system comprising one or both of a redox system and an organic free-radical generating initiator to form a reaction mixture;
(c) introducing said reaction mixture to a reactor comprising a channel with removable sealing lid said reaction mixture having a depth of less than about 20 inches; and,
(d) allowing the monomer(s) present in said reaction mixture to polymerize to form a water-soluble polymer gel product, each of said steps (b)-(d) being carried out in the substantial absence of molecular oxygen.

2. The process of claim 1 wherein the concentration of monomer(s) in said solution of step (a) is about 20 wt. % to about 60 wt. %.

3. The process of claim 1 wherein said redox system comprise sodium bisulfite and ammonium persulfate.

4. The process of claim 1 wherein said organic free radical generating initiator is an azo initiator.

5. The process of claim 4 wherein said azo initiator is 2,2′-azobis (2-amidinopropane) hydrochloride.

6. The process of claim 1 wherein said monomer solution of step (a) is purged of oxygen with an inert gas prior to stop (b), said channel reactor is purged of oxygen with an inert gas prior to step (c), and the components of said catalyst system are added to said monomer solution stepwise with mixing between steps.

7. The process of claim 6 wherein said redox system comprises at least two essential components, and at least one of said components is added to said monomer solution after addition of said organic free radical generating initiator.

8. The process of claim 1 wherein said reaction mixture has a depth of at least about two inches.

9. The process of claim 8 wherein said reaction mixture has a depth of about ten inches or less.

10. The process of claim 9 wherein said reaction mixture has a depth of about six to about eight inches.

11. The process of claim 1 comprising harvesting the gel, coarse-grinding and extruding gel particles or pellets and coating said particles or pellets to produce a pumpable and packageable product.

12. The process of claim 11 comprising coating the gel particles or pellets with a lubricating, non-water-soluble material, so as to allow the particles or pellets to remain as distinct entities when packaged, stored, or pumped.

13. The process wherein the lubricating material is a mineral oil or a vegetable oil.

14. The process of claim 13 wherein the lubricating material is an edible vegetable oil.

15. The process of claim 14 wherein the edible vegetable oil is canola oil.

16. The process of claim 13 comprising adding a high HLB surfactant to the oil in an amount such that the mixture of oil and surfactant provides a coating that provides pellet lubricity, pumpability, and separability.

17. The process of claim 16 wherein the surfactant is an oil-in-water surfactant having an HLB from 12 to 20.

18. The process of claim 12 where the particles or pellets are coated with up to 5.0 wt % of the lubricating material.

19. The process of claim 18 wherein the particles or pellets are up to 1/16 inch in length and width.

20. The process of claim 12 where the particles or pellets are coated with up to 2.0 wt % of the lubricating material.

21. The process of claim 20 wherein the particles or pellets are up to ¼ inch in length and width.

22. The process of claim 1 comprising drying the harvested, ground, and coated gel pellets to produce a granular product.
